(19) United States
(12) Patent Application Publication
(10) Pub. No.: US 2024/0422702 A1
(43) Pub. Date: Dec. 19, 2024

(54) ANTENNA APPARATUS, PROCESSING METHOD, AND RECORDING MEDIUM

(71) Applicant: NEC Corporation, Tokyo (JP)

(72) Inventors: Sou OFUDE, Tokyo (JP); Kenichi HOSHI, Tokyo (JP); Yoshiyuki ISHII, Tokyo (JP); Mizuki NIKAIDO, Tokyo (JP)

(73) Assignee: NEC Corporation, Tokyo (JP)

(21) Appl. No.: 18/731,495

(22) Filed: Jun. 3, 2024

(30) Foreign Application Priority Data
Jun. 13, 2023 (JP) 2023-096918

(51) Int. Cl. H04W 52/52; H01Q 3/08; H04B 10/40; H04W 84/06

(52) U.S. Cl. CPC H04W 52/52; H01Q 3/08; H04B 10/40; H04B 2210/006; H04W 84/06

(57) ABSTRACT

An antenna apparatus includes: an antenna that transmits and receives signals; antenna-side equipment that transmits and receives signals to and from the antenna, and a base that rotatably supports the antenna; a slip ring that transmits and receives electrical signals with the antenna-side equipment and base-side equipment included in the base; an optical rotary joint that transmits and receives optical signals to and from the antenna-side equipment and the base-side equipment included in the base; and an amplifier that performs a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

This application is based upon and claims the benefit of priority from Japanese patent application No. 2023-096918, filed on Jun. 13, 2023, the disclosure of which is incorporated herein in its entirety by reference.

### TECHNICAL FIELD

The present disclosure relates to an antenna apparatus, a processing method, and a recording medium.

### BACKGROUND ART

Antenna apparatuses that communicate while tracking artificial satellites are provided with antennas having axes (hereinafter referred to as the “AZ axis” and the “EL axis”) on which an azimuth angle (AZ angle) and an elevation angle (EL angle) are respectively adjusted, and track the artificial satellites while adjusting the angles about the AZ axis and the EL axis. Japanese Publication No. 2017-020902 discloses, as related art, the use of a rotary joint for propagating signals.

### SUMMARY

In an antenna apparatus that ceaselessly communicates for 24 hours while tracking an artificial satellite, an antenna on a base should preferably be able to rotate limitlessly in the AZ axis direction so as to be able to freely change the orientation thereof. However, signals must be transmitted and received to and from base-side equipment provided in a base and antenna-side equipment provided on the antenna side, even while continuing to rotate the antenna. For this reason, generally, when the signals are transmitted and received via a cable, rotation of the antenna on the base in the AZ axis direction will cause the cable to be wound about a support structure extending in the axial direction thereof. For this reason, when transmitting and receiving the signals via a cable, the range over which the antenna on the base can be rotated in the AZ axis direction is limited, and the antenna on the base cannot rotate limitlessly in the AZ axis direction. Therefore, one might conceive of transmitting and receiving the signals by using an optical rotary joint as described in Patent Document 1 instead of a cable. An optical rotary joint is a rotary joint that can transmit multiple signals in a limitless rotation state. For this reason, when an optical rotary joint is used, the range of possible rotation of an antenna on a base in the AZ axis direction is not limited. However, a large amount of power cannot be passed through an optical rotary joint. For this reason, when an optical rotary joint is used, a problem arises in that the antenna cannot be supplied with the transmission power necessary for communication. Additionally, when an optical rotary joint is used to supply transmission power to the upper portion of an antenna, a problem arises in that the signal strength varies depending on the rotation angle in the AZ axis direction due to the characteristics of the optical rotary joint. On the other hand, the permissible deviation in transmission power is defined by radio laws. Thus, the transmission power must be held constant. Therefore, technology is sought that can allow an antenna on a base to rotate limitlessly in the AZ axis direction and that can also supply the antenna with the transmission power necessary for communication.

An example objective of aspects of the present disclosure is to provide an antenna apparatus, a processing method, and a program that can solve the problems mentioned above.

In order to achieve the above-mentioned objective, according to an example aspect of the present disclosure, there is provided an antenna apparatus including: an antenna that transmits and receives signals; antenna-side equipment that transmits and receives signals to and from the antenna; a base that rotatably supports the antenna; a slip ring that transmits and receives electrical signals to and from the antenna-side equipment and base-side equipment included in the base; an optical rotary joint that transmits and receives optical signals to and from the antenna-side equipment and the base-side equipment included in the base; and an amplifier that performs a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

In order to achieve the above-mentioned objective, according to another example aspect of the present disclosure, there is provided a processing method performed by an antenna apparatus wherein an antenna transmits and receives signals, antenna-side equipment transmits and receives signals to and from the antenna, a base rotatably supports the antenna, a slip ring transmits and receives electrical signals to and from the antenna-side equipment and base-side equipment included in the base, and an optical rotary joint transmits and receives optical signals to and from the antenna-side equipment and the base-side equipment included in the base, the processing method comprising performing a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

In order to achieve the above-mentioned objective, according to another example aspect of the present disclosure, there is provided a non-transitory computer-readable recording medium storing a program causing a computer system included in an antenna apparatus comprising an antenna that transmits and receives signals; antenna-side equipment that transmits and receives signals to and from the antenna, and a base that rotatably supports the antenna; a slip ring that transmits and receives electrical signals to and from the antenna-side equipment and base-side equipment included in the base; and an optical rotary joint that transmits and receives optical signals to and from the antenna-side equipment and the base-side equipment included in the base; wherein the program makes the computer execute a process for controlling amplification by the amplifier to cancel out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

According to the example aspects of the present disclosure, an antenna on a base can limitlessly rotate in the AZ axis direction and an antenna can be supplied with the transmission power necessary for communication.

### BRIEF DESCRIPTION OF THE DRAWINGS

FIG. 1 is a diagram illustrating an example of the configuration of an antenna apparatus according to example embodiments of the present disclosure.

FIG. 2 is a diagram illustrating an example of the configurations of antenna-side equipment and base-side equipment according to example embodiments of the present disclosure.

FIG. 3 is a diagram illustrating an example of the configuration of a transmission processing unit according to example embodiments of the present disclosure.

FIG. 4 is a diagram illustrating an example of a data table according to example embodiments of the present disclosure.

FIG. 5 is a diagram illustrating an example of the processing flow in an antenna apparatus according to example embodiments of the present disclosure.

FIG. 6 is a diagram illustrating the minimum configuration of an antenna apparatus according to example embodiments of the present disclosure.

FIG. 7 is a diagram illustrating example examples of the processing flow in the antenna apparatus with the minimum configuration according to example embodiments of the present disclosure.

FIG. 8 is a schematic block diagram illustrating the configuration of a computer according to at least one example embodiment.

### EXAMPLE EMBODIMENT

Hereinafter, example embodiments will be explained in detail with reference to the drawings.

### (Configuration of Antenna Apparatus)

The antenna device 1 according to an example embodiment of the present disclosure will be explained with reference to the drawings. The antenna apparatus 1 is an apparatus for communicating while tracking an artificial satellite, the apparatus being able to rotate limitlessly about the AZ (AZimuth) axis and to realize a desired transmission signal magnitude.

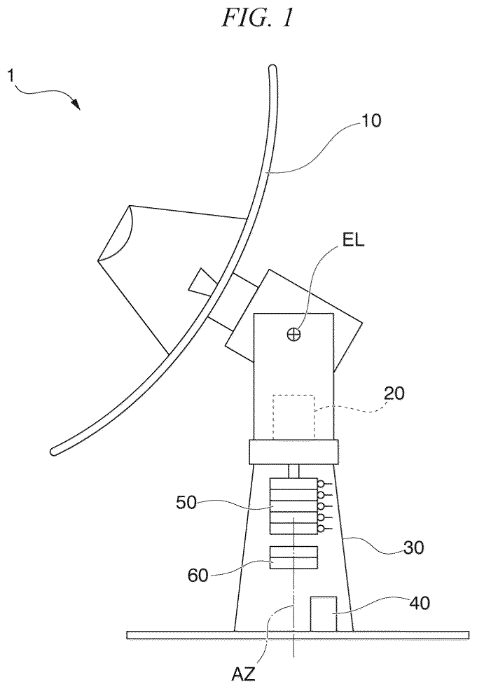

FIG. 1 is a diagram illustrating an example of the configuration of an antenna apparatus 1 according to example embodiment of the present disclosure. The antenna apparatus 1 includes an antenna 10, antenna-side equipment 20, a base 30, base-side equipment 40, a slip ring 50, and an optical rotary joint 60 as illustrated in FIG. 1.

The antenna 10 transmits and receives signals with respect to artificial satellites, and the like, which are tracking targets. The antenna 10, such as a parabola antenna, a Cassegrain antenna, a Gregorian antenna, or a ring focus antenna, has the function of using one or more reflectors having curved surfaces to collect reception signals at a focal position or to send out transmission signals from the focal position to the reflectors.

The antenna-side equipment 20 transmits and receives signals to and from the antenna 10. Additionally, the antenna-side equipment 20 transmits and receives signals to and from the base-side equipment 40 via the slip ring 50 and the optical rotary joint 60. The antenna-side equipment 20 will be described below in detail. The base 30 rotatably supports the antenna 10 and the antenna-side equipment 20.

The base-side equipment 40 is provided inside the base 30 or in the periphery of the base 30. The base-side equipment 40 transmits and receives signals to and from the antenna-side equipment 20 via the optical rotary joint 60 and the slip ring 50.

The slip ring 50 transmits and receives electrical signals to and from the antenna-side equipment 20 and the base-side equipment 40. The optical rotary joint 60 transmits and receives optical signals to and from the antenna-side equipment 20 and the base-side equipment 40.

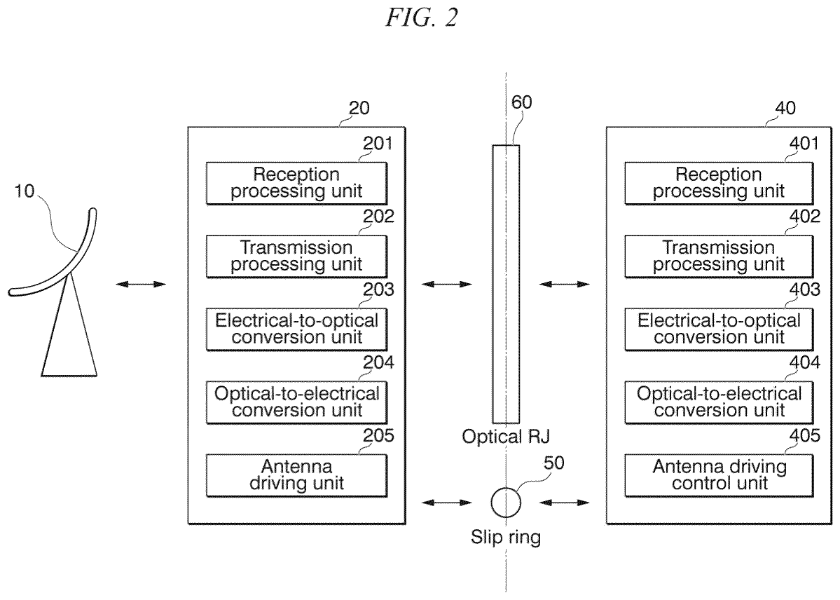

The antenna-side equipment 20 and the base-side equipment 40 will be explained in detail. FIG. 2 is a diagram indicating an example of the configuration of the antenna-side equipment 20 and the base-side equipment 40 according to example embodiments of the present disclosure. In FIG. 2, an antenna 10, a slip ring 50 and an optical rotary joint 60 are also indicated.

The antenna-side equipment 20 includes a reception processing unit 201, a transmission processing unit 202, an electrical-to-optical conversion unit 203, an optical-to-electrical conversion unit 204, and an antenna driving unit 205 as illustrated in FIG. 2.

The reception processing unit 201 receives reception signals from the antenna 10. The reception processing unit 201 performs prescribed processes on the received reception signals. Examples of the prescribed processes include amplification, frequency conversion (e.g., down-conversion), and the like. Among the reception signals on which prescribed processes have been executed, the reception processing unit 201 outputs, to the electrical-to-optical conversion unit 203, reception signals to be transmitted to the base-side equipment 40.

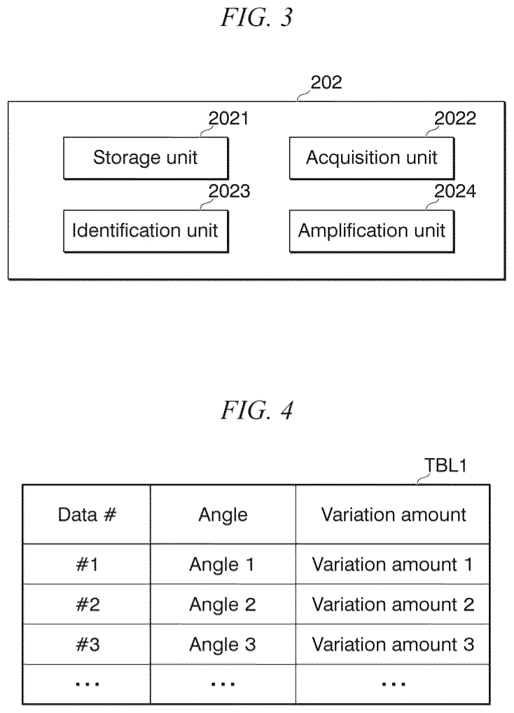

The transmission processing unit 202 converts the transmission signals into signals of a prescribed magnitude and outputs them to the antenna 10. FIG. 3 is a diagram illustrating an example of the configuration of the transmission processing unit 202 according to example embodiments of the present disclosure. The transmission processing unit 202 includes a storage unit 2021, an acquisition unit 2022, an identification unit 2023, and an amplification unit 2024 as illustrated in FIG. 3.

The storage unit 2021 stores information necessary for the various processes performed by the antenna-side equipment 20. For example, the storage unit 2021 associates respective angles of the optical rotary joint 60 with variation amounts of the transmission signals from a desired power at the respective angles, and stores the information in a data table TBL1. The correspondence between the respective angles of the optical rotary joint 60 and the variation amounts of the transmission signals from the desired power at the respective angles may, for example, be determined by being acquired in advance, and the like. Additionally, the variation amounts may be amounts indicated by absolute values. Additionally, the variation amounts may be amounts indicated by relative values, such as multiples, with respect to the desired power. FIG. 4 is a diagram illustrating an example of the data table TBL1 in example embodiments of the present disclosure. For example, in the data table TBL1 indicated in FIG. 4, an angle 1 of the optical rotary joint 60 is associated with a variation amount 1 from the desired power of the transmission signal. Additionally, in the data table TBL1, an angle 2 of the optical rotary joint 60 is associated with a variation amount 2 from the desired power of the transmission signal. Additionally, in the data table TBL1, an angle 3 of the optical rotary joint 60 is associated with a variation amount 3 from the desired power of the transmission signal.

The acquisition unit 2022 acquires information including the current angle (an example of an actual angle) of the optical rotary joint 60. For example, if the optical rotary joint 60 can detect its own current angle, then the acquisition unit 2022 directly acquires the information including the current angle from the optical rotary joint 60. Additionally, if the optical rotary joint 60 cannot detect its own current angle, the acquisition unit 2022 acquires control information from an antenna driving control unit 405 described below that controls the driving of the antenna 10, via the slip ring 50, or from the antenna driving unit 205 that has received control signals from the antenna driving control unit 405. Then, the acquisition unit 2022 may identify the current angle of the optical rotary joint 60 by computation from the received control information.

In the respective example embodiments of the present disclosure, the processes such as “acquiring” and “receiving” are not limited to cases in which a target thereof (including information) is directly received, but may also include cases in which the target is obtained by performing computations or processing on something (including information) that has been directly received.

The identification unit 2023 identifies, in the data table TBL1 stored in the storage unit 2021, an angle that is the same as the current angle of the optical rotary joint 60 included in the information acquired by the acquisition unit 2022. Furthermore, the identification unit 2023 identifies a variation amount associated with the identified angle in the data table TBL1. For example, if the current angle of the optical rotary joint 60 included in the information acquired by the acquisition unit 2022 is the angle 1, the identification unit 2023 identifies the angle 1 in the data table TBL1. Then, the identification unit 2023 identifies the variation amount 1 associated with the identified angle 1 in the data table TBL1.

The amplification unit 2024 performs a process for cancelling out the variation amount identified by the identification unit 2023. For example, the amplification unit 2024 changes its own amplification rate for amplifying transmission signals to an amplification rate for cancelling out the variation amount identified by the identification unit 2023. Alternatively, for example, the amplification unit 2024 newly adds an amplifier or an attenuator for cancelling out the variation amount identified by the identification unit 2023. The amplification unit 2024 outputs, to the antenna 10, the transmission signal obtained after having performed the process for cancelling out the variation amount identified by the identification unit 2023.

The electrical-to-optical conversion unit 203 receives electrical signals from the reception processing unit 201. The electrical-to-optical conversion unit 203 converts the received electrical signals into optical signals. The electrical-to-optical conversion unit 203 outputs the converted optical signals to the optical rotary joint 60.

The optical-to-electrical conversion unit 204 receives optical signals from the optical rotary joint 60. The optical-to-electrical conversion unit 204 converts the received optical signals into electrical signals. The optical-to-electrical conversion unit 204 outputs the converted electrical signals to the transmission processing unit 202.

The antenna driving unit 205 drives the antenna 10 so that the orientation of the antenna 10 becomes a desired orientation under control by the antenna driving control unit 405 to be described below. Specifically, the antenna driving unit 205 receives driving control signals for changing the orientation of the antenna 10 from the antenna driving control unit 405 via the slip ring 50. The driving control signals are signals including power and electrical signals for obtaining the torque or the rotation speed necessary for driving the antenna 10 to an elevation angle direction (about the EL (ELevation) axis) and an azimuth angle direction (about the AZ axis). The antenna driving unit 205 changes the orientation of the antenna 10 in response to the received driving control signals.

The base-side equipment 40 includes a reception processing unit 401, a transmission processing unit 402, an electrical-to-optical conversion unit 403, an optical-to-electrical conversion unit 404, and an antenna driving control unit 405 as illustrated in FIG. 2.

The reception processing unit 401 receives electrical signals from the optical-to-electrical conversion unit 404. The reception processing unit 401 performs prescribed processes on the received electrical signals. Examples of the prescribed processes include demodulation processes, processes for state monitoring data (i.e., telemetry), which is information needed for monitoring the states of satellites from the ground, processes for antenna direction error information with respect to satellites, and the like. The antenna direction error information includes information on sum signals and difference signals for tracking satellites with the antenna by a monopulse tracking scheme. A sum signal is a signal having characteristics such that the signal level has a maximum when directly pointing to a satellite and the signal level decreases when the direction shifts away from the satellite direction. A difference signal is a signal having characteristics such that the signal has a minimum when directly pointing to a satellite, the signal level increases when the direction shifts away from the satellite direction, and the phase deviates from that of the sum signal in accordance with the direction of the shift. Examples of a process for the antenna direction error information include a process for determining the angular error on the AZ axis and the angular error on the EL axis for the antenna from the sum signal and the difference signal, and the like. These prescribed processes may use well-known art. The state monitoring data includes information indicating the temperature inside the satellite, the voltage at a prescribed location inside the satellite, the posture of the satellite, the state of equipment mounted in the satellite, and the like.

The transmission processing unit 402 outputs transmission signals on which prescribed processes have been performed to the antenna-side equipment 20 via the electrical-to-optical conversion unit 403 and the optical rotary joint 60. Examples of the prescribed processes include modulation processes, processes for generating transmission signals of a prescribed magnitude, and the like.

The electrical-to-optical conversion unit 403 receives electrical signals from the transmission processing unit 402. The electrical-to-optical conversion unit 403 converts the received electrical signals into optical signals. The electrical-to-optical conversion unit 403 outputs the converted optical signals to the optical rotary joint 60.

The optical-to-electrical conversion unit 404 receives optical signals from the optical rotary joint 60. The optical-to-electrical conversion unit 404 converts the received optical signals into electrical signals. The optical-to-electrical conversion unit 404 outputs the converted electrical signals to the reception processing unit 401.

The antenna driving control unit 405 generates driving control signals for driving the antenna 10 so that the orientation of the antenna 10 becomes a desired orientation (i.e., an orientation facing in the direction of an artificial satellite) based on antenna direction error information. The antenna direction error information is information indicating how much the antenna is off from the satellite direction in the case where the antenna is to be oriented in the direction of a target satellite by a monopulse tracking scheme, and the like. This antenna direction error information may sometimes be angular error information. The antenna receives signals from a higher-order mode coupler and the like which are provided on the antenna side. Sum signals and difference signals are generated from signals received by the antenna by a higher-order mode coupler and the like which are provided on the antenna side, based on the angular error between the direction in which the antenna is oriented and the direction in which the satellite is actually located. The angular error is indicated by the angular signals information. The sum signals and the difference signals are respectively transmitted to the reception processing unit 401. Then, the reception processing unit 401 computes the angular errors, respectively, on the AZ axis and the EL axis from the phase differences and level differences, and the like between the sum signals and the difference signals. Then, the antenna driving control unit 405 outputs the generated driving control signals to the antenna-side equipment 20 via the slip ring 50.

The above-mentioned processes performed by the antenna apparatus 1 are merely one example, and the processes performed by the antenna apparatus 1 are not limited to those mentioned above. For example, the antenna apparatus 1 may perform the processes explained below.

### (Processes Performed by Antenna Apparatus)

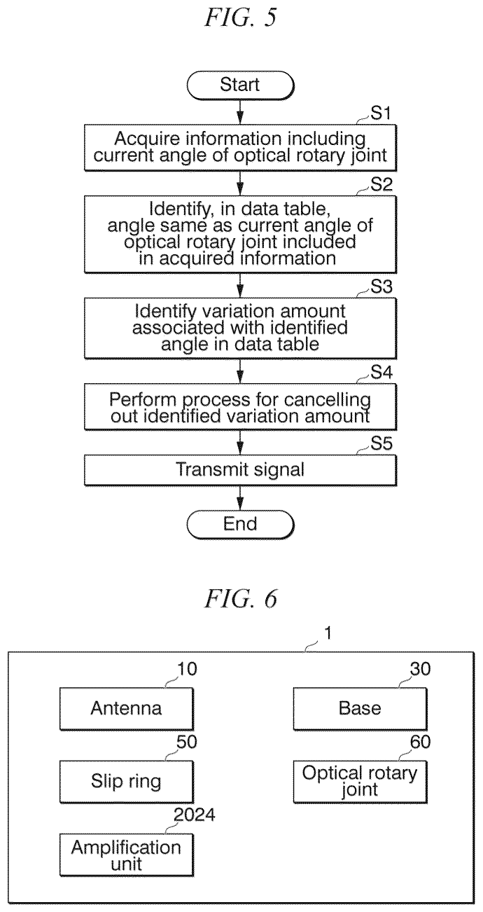

FIG. 5 is a diagram illustrating an example of the processing flow in the antenna apparatus 1 according to example embodiments of the present disclosure. Next, the process performed by the antenna apparatus 1 to change the magnitude of the transmission signal output to the antenna 10 by the antenna-side equipment 20 to a desired magnitude will be explained with reference to FIG. 5. It is assumed that the reception processing unit 401 performs the processing of antenna direction error information. Additionally, it is assumed that the antenna driving control unit 405 generates driving control signals for driving the antenna 10 so that the orientation of the antenna 10 becomes a desired orientation (i.e., an orientation facing in the direction of an artificial satellite) based on the processing of antenna direction error information performed by the reception processing unit 401. Furthermore, it is assumed that the antenna driving control unit 405 outputs the generated driving control signals to the antenna-side equipment 20 via the slip ring 50. Additionally, it is assumed that the antenna driving unit 205 drives the antenna 10 so that the orientation of the antenna 10 becomes a desired orientation under control by the antenna driving control unit 405.

The transmission processing unit 402 outputs transmission signals on which prescribed processing has been performed to the antenna-side equipment 20 via the electrical-to-optical conversion unit 403 and the optical rotary joint 60. The electrical-to-optical conversion unit 403 receives electrical signals from the transmission processing unit 402. The electrical-to-optical conversion unit 403 converts the received electrical signals into optical signals. The electrical-to-optical conversion unit 403 outputs the converted optical signals to the optical rotary joint 60.

The optical-to-electrical conversion unit 204 receives optical signals from the optical rotary joint 60. The optical-to-electrical conversion unit 204 converts the received optical signals into electrical signals. The optical-to-electrical conversion unit 204 outputs the converted electrical signals to the transmission processing unit 202.

The acquisition unit 2022 acquires information including the current angle of the optical rotary joint 60 (step S1). The identification unit 2023 identifies an angle that is the same as the current angle of the optical rotary joint 60 included in the information acquired by the acquisition unit 2022 in the data table TBL1 stored in the storage unit 2021 (step S2). Then, the identification unit 2023 identifies the variation amount associated with the identified angle in the data table TBL1 (step S3).

The amplification unit 2024 performs a process for cancelling out the variation amount identified by the identification unit 2023 (step S4). The amplification unit 2024 outputs, to the antenna 10, transmission signals on which the process for cancelling out the variation amount identified by the identification unit 2023 have been performed. The antenna 10 transmits the signals to an artificial satellite that is being tracked (step S5).

### (Advantages)

The antenna apparatus 1 according to an example embodiment of the present disclosure has been explained above. In the antenna apparatus 1, the antenna 10 transmits and receives signals. The base 30 rotatably supports the antenna 10 and antenna-side equipment 20 that transmits and receives signals to and from the antenna 10. The slip ring 50 transmits and receives electrical signals to and from the antenna-side equipment 20 and the base-side equipment 40 provided in the base 30. The optical rotary joint 60 transmits and receives optical signals to and from the antenna-side equipment 20 and the base-side equipment 40 provided in the base 30. The amplification unit 2024 performs a process for cancelling out the variation amounts of actual transmission signals from a desired power at actual angles of the optical rotary joint 60 based on the actual angles of the optical rotary joint 60 and a correspondence relationship between respective angles of the optical rotary joint 60 and variation amounts of transmission signals from the desired power at the respective angles. Due to this antenna apparatus 1, the antenna on the base can limitlessly rotate in the AZ axis direction and can supply the antenna with the transmission power necessary for communication.

FIG. 6 is a diagram illustrating the minimum configuration of the antenna apparatus 1 according to example embodiments disclosed herein. The antenna apparatus 1 includes an antenna 10, a base 30, a slip ring 50, an optical rotary joint 60, and an amplification unit 2024 as illustrated in FIG. 6.

The antenna 10 transmits and receives signals. The base 30 rotatably supports the antenna 10 and antenna-side equipment 20 that transmits and receives signals to and from the antenna 10. A slip ring 50 transmits and receives electrical signals to and from the antenna-side equipment 20 and base-side equipment 40 provided in the base 30. An optical rotary joint 60 transmits and receives optical signals to and from the antenna-side equipment 20 and the base-side equipment 40 provided in the base 30. An amplification unit 2024 performs a process for cancelling out the variation amount of an actual transmission signal from a desired power at an actual angle of the optical rotary joint 60 based on the actual angle of the optical rotary joint 60 and a correspondence relationship between respective angles of the optical rotary joint 60 and variation amounts of transmission signals from the desired power at the respective angles.

The antenna 10 can be realized, for example, by using functions of the antenna 10 illustrated in FIG. 1. The base 30 can be realized, for example, by using the functions of the base 30 illustrated in FIG. 1. The slip ring 50 can be realized, for example, by using the functions of the slip ring 50 illustrated in FIG. 1. The optical rotary joint 60 can be realized, for example, by using the functions of the optical rotary joint 60 illustrated in FIG. 1. The amplification unit 2024 can be realized, for example, by using the functions of the amplification unit 2024 illustrated in FIG. 3.

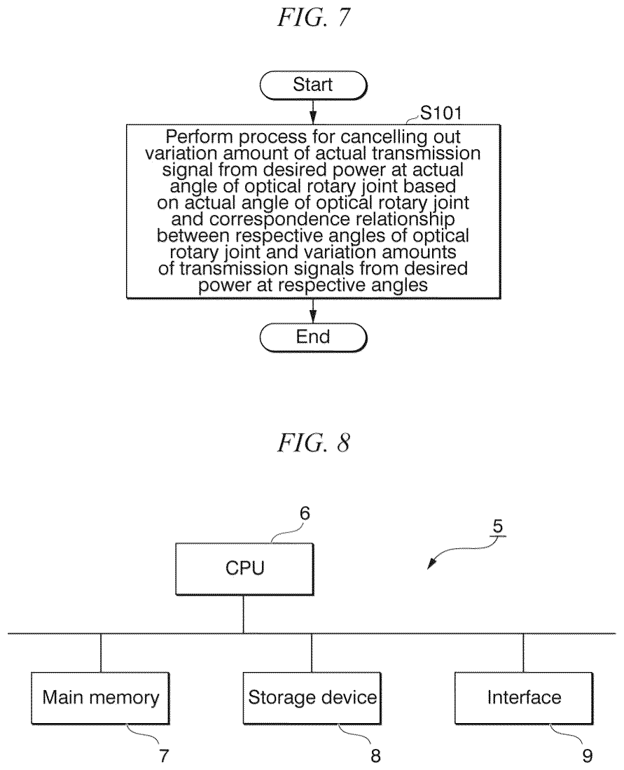

FIG. 7 is a diagram illustrating an example of the processing flow in the antenna apparatus 1 with the minimum configuration according to example embodiments of the present disclosure. Next, the processing in the antenna apparatus 1 with the minimum configuration according to the example embodiment of the present disclosure will be explained with reference to FIG. 7.

In an antenna apparatus 1 including an antenna 10 that transmits and receives signals, antenna-side equipment 20 that transmits and receives signals to and from the antenna 10, a base 30 that rotatably supports the antenna 10, a slip ring 50 that transmits and receives electrical signals to and from the antenna-side equipment 20 and base-side equipment 40 provided in the base 30, and an optical rotary joint 60 that transmits and receives optical signals to and from the antenna-side equipment 20 and the base-side equipment 40 provided in the base 30, an amplification unit 2024 performs a process for cancelling out the variation amount of an actual transmission signal from a desired power at an actual angle of the optical rotary joint 60 based on the actual angle of the optical rotary joint 60 and a correspondence relationship between respective angles of the optical rotary joint 60 and variation amounts of transmission signals from the desired power at the respective angles (step S101).

The antenna apparatus 1 with the minimum configuration according to an example embodiment of the present disclosure has been explained above. Due to this antenna apparatus 1, the antenna on the base can limitlessly rotate in the AZ axis direction and the antenna can be supplied with the transmission power necessary for communication.

In the processing in the example embodiment of the present disclosure, the order of the processes may be switched within the range in which appropriate processing is performed.

Although example embodiments of the present disclosure have been explained, the antenna apparatus 1, the antenna-side equipment 20, the base-side equipment 40, and other control apparatuses mentioned above may have internal computer systems. Furthermore, the steps in the above-mentioned processes are stored in a computer-readable recording medium in the form of a program and the above-mentioned processes are performed by a computer reading and executing this program. Specific examples of the computer will be indicated below.

FIG. 8 is a schematic block diagram illustrating the configuration of a computer according to at least one example embodiment. The computer 5 includes a CPU (Central Processing Unit) 6, a main memory 7, a storage device 8, and an interface 9 as illustrated in FIG. 8.

For example, the antenna apparatus 1, the antenna-side equipment 20, the base-side equipment 40, and other control apparatuses mentioned above may each be implemented by the computer 5. Furthermore, the operations of the respective processing units mentioned above are stored in the storage device 8 in the form of a program. The CPU 6 reads the program from the storage device 8 and loads the program in the main memory 7, then executes the processes mentioned above in accordance with said program. Additionally, the CPU 6 secures, in the main memory 7, storage areas corresponding to the respective storage units mentioned above in accordance with the program.

Examples of storage devices 8 include HDDs (Hard Disk Drives), SSDs (Solid State Drives), magnetic disks, magneto-optic disks, CD-ROMs (Compact Disc Read-Only Memory), DVD-ROMs (Digital Versatile Disc Read-Only Memory), semiconductor memory, and the like. The storage device 8 may be internal media directly connected to a bus in the computer 5, or may be external media connected to the computer 5 by an interface 9 or by a communication line. Additionally, in the case where the program is distributed to the computer 5 by a communication line, the computer 5 that has received the distribution may load the program in the main memory 7 and execute the processes mentioned above. In at least one example embodiment, the storage device 8 is a non-transitory and tangible storage medium.

Additionally, the program mentioned above may realize just some of the functions mentioned above. Furthermore, the above-described program may be a so-called difference file (difference program) that can realize the functions mentioned above in combination with a program already recorded in a computer system.

While a number of example embodiments of the present disclosure have been explained, these example embodiments are merely exemplary and do not limit the scope of the disclosure. Various additions, omissions, substitutions, and modifications can be made to these example embodiments within a range not departing from the spirit of the disclosure.

While preferred example embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

Some or all of the example embodiments mentioned above may be described as in the appendices below, yet are not limited thereto.

### (Supplementary Note 1)

An antenna apparatus comprising:
an antenna that transmits and receives signals;
antenna-side equipment that transmits and receives signals to and from the antenna;
a base that rotatably supports the antenna;
a slip ring that transmits and receives electrical signals to and from the antenna-side equipment and base-side equipment included in the base;
an optical rotary joint that transmits and receives optical signals to and from the antenna-side equipment and the base-side equipment included in the base; and
an amplifier that performs a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

### (Supplementary Note 2)

The antenna apparatus according to Supplementary Note 1, further comprising:
a storage unit that stores a data table indicating the correspondence relationship between the respective angles of the optical rotary joint and the variation amounts of transmission signals from the desired power at the respective angles.

### (Supplementary Note 3)

The antenna apparatus according to Supplementary Note 1 or 2, further comprising:
a processor that acquires information including the actual angle of the optical rotary joint.

### (Supplementary Note 4)

The antenna apparatus according to Supplementary Note 3, wherein
the processor acquires the information including the actual angle of the optical rotary joint from the optical rotary joint or from an antenna driving control unit that generates a control signal for driving the antenna.

### (Supplementary Note 5)

The antenna apparatus according to any one of Supplementary Note 1 to 4, wherein
the antenna transmits the transmission signal after the amplifier has performed the process for cancelling out the variation amount.

### (Supplementary Note 6)

A processing method performed by an antenna apparatus wherein an antenna transmits and receives signals, antenna-side equipment transmits and receives signals to and from the antenna, a base rotatably supports the antenna, a slip ring transmits and receives electrical signals to and from the antenna-side equipment and base-side equipment included in the base, and an optical rotary joint transmits and receives optical signals to and from the antenna-side equipment and the base-side equipment included in the base,
the processing method comprising performing a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

### (Supplementary Note 7)

A non-transitory computer-readable recording medium storing a program causing a computer system included in an antenna apparatus comprising an antenna that transmits and receives signals; antenna-side equipment that transmits and receives signals to and from the antenna, and a base that rotatably supports the antenna; a slip ring that transmits and receives electrical signals to and from the antenna-side equipment and base-side equipment included in the base; and an optical rotary joint that transmits and receives optical signals to and from the antenna-side equipment and the base-side equipment included in the base;
wherein the program makes the computer execute a process for controlling amplification by the amplifier to cancel out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

What is claimed is:

1. An antenna apparatus comprising:
an antenna that transmits and receives signals;
antenna-side equipment that transmits and receives signals to and from the antenna;
a base that rotatably supports the antenna;
a slip ring that transmits and receives electrical signals to and from the antenna-side equipment and base-side equipment included in the base;
an optical rotary joint that transmits and receives optical signals to and from the antenna-side equipment and the base-side equipment included in the base; and
an amplifier that performs a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

2. The antenna apparatus according to claim 1, further comprising:
a storage unit that stores a data table indicating the correspondence relationship between the respective angles of the optical rotary joint and the variation amounts of transmission signals from the desired power at the respective angles.

3. The antenna apparatus according to claim 1, further comprising:
a processor that acquires information including the actual angle of the optical rotary joint.

4. The antenna apparatus according to claim 3, wherein
the processor acquires the information including the actual angle of the optical rotary joint from the optical rotary joint or from an antenna driving control unit that generates a control signal for driving the antenna.

5. The antenna apparatus according to claim 1, wherein
the antenna transmits the transmission signal after the amplifier has performed the process for cancelling out the variation amount.

6. A processing method performed by an antenna apparatus wherein an antenna transmits and receives signals, antenna-side equipment transmits and receives signals to and from the antenna, a base rotatably supports the antenna, a slip ring transmits and receives electrical signals to and from the antenna-side equipment and base-side equipment included in the base, and an optical rotary joint transmits and receives optical signals to and from the antenna-side equipment and the base-side equipment included in the base,
the processing method comprising performing a process for cancelling out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.

7. A non-transitory computer-readable recording medium storing a program causing a computer system included in an antenna apparatus comprising an antenna that transmits and receives signals; antenna-side equipment that transmits and receives signals to and from the antenna, and a base that rotatably supports the antenna; a slip ring that transmits and receives electrical signals to and from the antenna-side equipment and base-side equipment included in the base; and an optical rotary joint that transmits and receives optical signals to and from the antenna-side equipment and the base-side equipment included in the base;
wherein the program makes the computer execute a process for controlling amplification by the amplifier to cancel out a variation amount of an actual transmission signal from a desired power at an actual angle of the optical rotary joint based on the actual angle of the optical rotary joint and a correspondence relationship between respective angles of the optical rotary joint and variation amounts of transmission signals from the desired power at the respective angles.
